(19) United States
(12) Patent Application Publication
(10) Pub. No.: US 2016/0078765 A1
(43) Pub. Date: Mar. 17, 2016

(54) DEVICE, SYSTEM AND METHOD FOR FINDING A PARKED VEHICLE

(71) Applicant: SKY LIGHT ELECTRONIC (SHENZHEN) LIMITED CORPORATION, Shenzhen (CN)

(72) Inventors: Zupei He, Shenzhen (CN); Weijun Gan, Shenzhen (CN); Yanbo Gong, Shenzhen (CN)

(73) Assignee: SKY LIGHT ELECTRONIC (SHENZHEN) LIMITED CORPORATION

(21) Appl. No.: 14/568,196

(22) Filed: Dec. 12, 2014

(30) Foreign Application Priority Data
Sep. 15, 2014 (CN) 201410468371.2

(51) Int. Cl. G08G 1/14

(52) U.S. Cl. CPC G08G 1/144

(57) ABSTRACT

Disclosed is a device for finding a parked vehicle, which is used for being installed in the vehicle and cooperated with a mobile communication terminal of user and includes a signal receiving module, a microprocessor and a location prompt module. The signal receiving module is remote wireless communication module, which is used for receiving a request signal sent by the mobile communication terminal in a way of sending text message or dialing; the microprocessor is connected with the signal receiving module and the location prompt module for sending a control signal to the location prompt module according to the request signal; and the location prompt module is provided for sending out a prompt signal according to the control signal so as to prompt the user where the parked vehicle is. In addition, there are further disclosed a system and a method for finding parked vehicle.

### CROSS-REFERENCE TO RELATED APPLICATIONS

This present invention claims the benefit of Chinese Patent Application No. CN201410468371.2, filed on Sep. 15, 2014, the contents of which are hereby incorporated by reference.

### FIELD OF THE INVENTION

The present invention relates to the technology of finding a parked vehicle and, in particular, it concerns a device, system and method for finding a parked vehicle.

### BACKGROUND OF THE INVENTION

With the development of technology, more and more motor vehicles enter the lives of people. The motor vehicles as mainly traffic tools changes the traditional way people travel and make the lives of people easier. With the rapid use of motor vehicles, there are provided large parking lots in public places, office building and residential area for parking. However, due to some reasons such as large space, similar environment and markers, difficult to orientate and so on, the vehicle owners will easily get lost in the large parking lots, and finally cannot find their vehicles.

In view of the above problems, there are some devices, which are capable of being installed in a vehicle for finding a parked vehicle, on the market. However, most of the existing devices for finding a parked vehicle utilize GPS technology to realize locating of vehicle in an open area or utilize infrared, Zigbee or WiFi to achieve short-distance communication so as to find a parked vehicle. However, the GPS technology can only achieve location on the same plane, which greatly limits its application; thus, the device using the GPS technology only applies to the vehicle parked at an open ground parking lot. When the vehicle is parked at a multi-story parking lot, the existing device for finding a parked vehicle with a GPS module cannot make an accurate positioning, moreover, the device including a GPS module has complicated structure and higher costs. And if it is achieved by means of infrared, Zigbee or WiFi, a remote control device is needed in order to control the device for finding a parked vehicle and it has limitation of distance, thus it usually cannot help the vehicle owners to find their vehicles.

Thus, it is necessary to provide a device for finding a parked vehicle with advantages of simple structure, convenience to use and strong practicability, and a system and a method thereof.

### SUMMARY OF THE INVENTION

One object of the present invention is to provide a device for finding a parked vehicle with advantages of simple structure, convenience to use and strong practicability.

Another object of the present invention is to provide a system for finding a parked vehicle with advantages of simple structure, convenience to use and strong practicability.

Still another object of the present invention is to provide a method for finding a parked vehicle with advantages of convenience to operate and strong practicability.

To achieve the above object, there is provided a device for finding a parked vehicle, which is used for being installed in a vehicle and cooperated with a mobile communication terminal of user. The device for finding a parked vehicle includes a signal receiving module, a microprocessor and a location prompt module. The signal receiving module is a remote wireless communication module, which is used for making wireless communication with the mobile communication terminal thereby receiving a request signal sent by the mobile communication terminal in a way of sending text message or dialing; the microprocessor is connected with the signal receiving module and the location prompt module for sending a control signal to the location prompt module according to the request signal received by the signal receiving module; and the location prompt module is provided for sending out a prompt signal according to the control signal from the microprocessor so as to prompt the user where the parked vehicle is.

Preferably, the remote wireless communication module is GSM module, CDMA module, CDMA2000 module, WCDMA module, TD-SCDMA module, TD-LTE module or FDD-LTE module.

Preferably, the device further includes a storage module, which is provided for storing preset user information; the request signal includes request information and real-time user information; and the microprocessor is connected with the storage module so as to obtain the preset user information stored in the storage module and then compare the preset user information with the real-time user information from the signal receiving module so as to determine whether the user is legitimate.

Preferably, the location prompt module includes a voice prompt unit and/or a light prompt unit; the voice prompt unit includes a loudspeaker and a loudspeaker drive circuit provided for driving the loudspeaker, the loudspeaker drive circuit being connected with and controlled by the microprocessor; and the light prompt unit includes a LED indicator and a LED driving circuit for driving the LED indicator, the LED driving circuit being connected with and controlled by the microprocessor.

To achieve the above object, there is further provided a system for finding a parked vehicle, comprising a device for finding a parked vehicle which is installed in the vehicle and a mobile communication terminal of user. The mobile communication terminal includes a signal sending module, which is a remote wireless communication module, provided for sending request signal to the device in a way of sending text message or dialing; the device for finding a parked vehicle includes a signal receiving module, a microprocessor and a location prompt module; the signal receiving module is a remote wireless communication module, which is used for making wireless communication with the mobile communication terminal thereby receiving a request signal from the signal sending module; the microprocessor is connected with the signal receiving module and the location prompt module for sending a control signal to the location prompt module according to the request signal received by the signal receiving module; and the location prompt module is provided for sending out a prompt signal according to the control signal from the microprocessor so as to prompt the user where the parked vehicle is.

Preferably, a communication trigger module is provided in the mobile communication terminal for triggering the mobile communication terminal to send text message or dial to the device automatically.

Preferably, the device further includes a storage module, which is provided for storing preset user information; the request signal includes request information and real-time user information; and the microprocessor is connected with the storage module so as to obtain the preset user information stored in the storage module and then compare the preset user information with the real-time user information from the signal receiving module so as to determine whether the user is legitimate.

Preferably, the location prompt module includes a voice prompt unit and/or a light prompt unit; the voice prompt unit includes a loudspeaker and a loudspeaker drive circuit provided for driving the loudspeaker, the loudspeaker drive circuit being connected with and controlled by the microprocessor; and the light prompt unit includes a LED indicator and a LED driving circuit for driving the LED indicator, the LED driving circuit is connected with and controlled by the microprocessor.

To achieve the above object, there is further provided a method for finding a parked vehicle based on the above-mentioned system, which includes following steps: (a) the mobile communication terminal sends a request signal to the device in a way of sending text message or dialing; (b) the signal receiving module of the device receives the request signal; (c) the microprocessor of the device sends a control signal to the location prompt module according to the request signal received by the signal receiving module; and (d) the location prompt module sends out a prompt signal according to the control signal from the microprocessor so as to prompt the user where the parked vehicle is.

Preferably, the device further includes a storage module, which is provided for storing preset user information; the request signal includes request information and real-time user information; the microprocessor is connected with the storage module so as to obtain the preset user information stored in the storage module; and the step (c) includes following steps: the microprocessor compares the real-time user information from the signal receiving module with the preset user information so as to determine whether the user is legitimate; if the real-time user information can match with the preset user information, the step (d) will be executed; and if the real-time user information cannot match with the preset user information, the device will not respond to the request signal sent by the mobile communication terminal and wait for a new request signal.

Compared with the prior art, the present invention has beneficial effects as follows: the device of the present invention is mainly composed of signal receiving module, microprocessor and location prompt module. By receiving external signal, the location prompt module can be started up so as to prompt the user where the parked vehicle is. Such a simple structure can achieve a function of finding a parked vehicle, which can significantly reduce costs. In addition, due to the signal receiving module being achieved by remote wireless communication module, the device of the present invention can be cooperated with a widely used mobile communication terminal such as mobile phone or tablet device with a function of telecommunication, thus no additional remote control device is needed in order to control the device for finding a parked vehicle. Thus, it is easy to use, has lower costs and it is not restricted by space and distance, all of which can meet the demand of consumers and then can bring good economic benefits.

Similarly, the system and method of the present invention also have the above-mentioned advantages.

The present invention will become clearer by means of the following description combining the accompanying drawings, which are used to illustrate embodiments of the present invention.

### BRIEF DESCRIPTION OF THE DRAWINGS

FIG. 1 is a block diagram of a device for finding a parked vehicle according to a first embodiment of the present invention;

FIG. 2 is a block diagram of a device for finding a parked vehicle according to a second embodiment of the present invention;

FIG. 3 is a block diagram of a device for finding a parked vehicle according to a third embodiment of the present invention;

FIG. 4 is a block diagram of a device for finding a parked vehicle according to a fourth embodiment of the present invention;

FIG. 5 is a block diagram of a system for finding a parked vehicle according to an embodiment of the present invention; and

FIG. 6 is a flow chart of a method for finding a parked vehicle according to an embodiment of the present invention.

### DETAILED DESCRIPTION OF ILLUSTRATED EMBODIMENTS

The technical solutions of embodiments will be clearly and completely described as follows by combining the figures of the embodiments of the present invention, and similar reference numbers in the figures represent similar components. Obviously, the embodiments described as follows are merely parts of embodiments of the present invention, but not the all. Based on the embodiments of the present invention, other embodiments created by one of ordinary skill in the art without creative work, all belong to the scope of protection of the present invention.

The device for finding a parked vehicle of the present invention is provided for being installed in a vehicle (by being installed directly or being integrated with an automobile data recorder or other automotive electronic products) and it is cooperated with a mobile communication terminal of user. The mobile communication terminal can make communication with the device, and after receiving the signal from the mobile communication terminal, the device will send out a prompt signal so as to prompt the user where the parked vehicle is, which is easy for user to find the target vehicle.

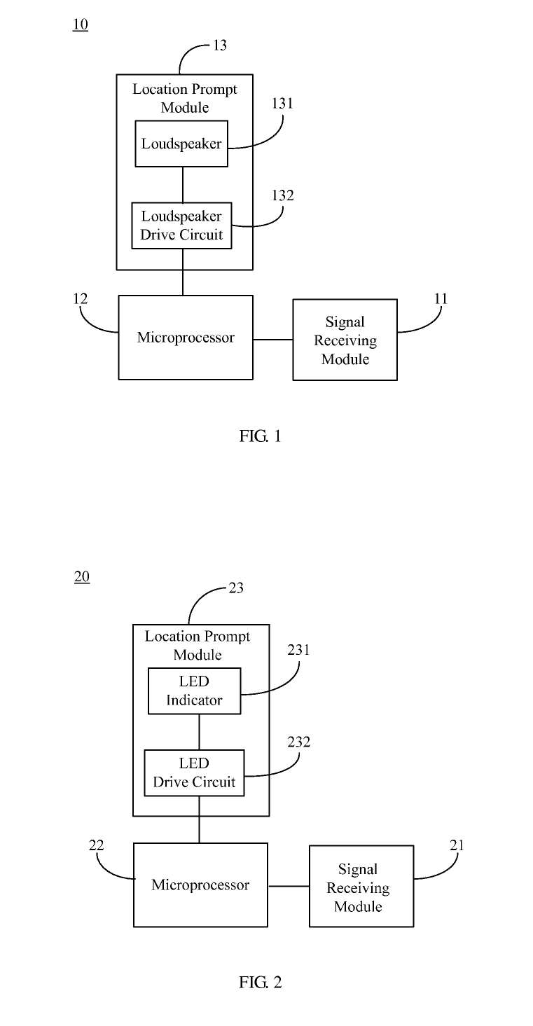

FIG. 1 illustrates a device for finding a parked vehicle according to the first embodiment of the present invention. Referring to FIG. 1, the device 10 according to this embodiment includes a signal receiving module 11, a microprocessor 12 and a location prompt module 13. The signal receiving module 11 is a remote wireless communication module, which can be a GSM module, CDMA module, CDMA2000 module, WCDMA module, TD-SCDMA module, TD-LTE module or FDD-LTE module, and it is capable of making wireless communication with the mobile communication terminal thereby receiving a request signal sent by the mobile communication terminal in a way of sending text message or dialing. The microprocessor 12 is connected with the signal receiving module 11 and the location prompt module 13 and it is used for sending a control signal to the location prompt module 13 according to the request signal received by the signal receiving module 11; and the location prompt module 13 is provided for sending out a prompt signal according to the control signal from the microprocessor 12 so as to prompt the user where the parked vehicle is. In this embodiment, the location prompt module 13 includes a loudspeaker 131 and a loudspeaker drive circuit 132 provided for driving the loudspeaker 131, the loudspeaker drive circuit 132 being connected with the microprocessor 12. When the location prompt module 13 is working under the control of the microprocessor 12, the loudspeaker 131 will play beep sound so as to provide guidance to user for finding a parked vehicle.

FIG. 2 illustrates a device for finding a parked vehicle according to the second embodiment of the present invention. Referring to FIG. 2, the device 20 according to this embodiment includes a signal receiving module 21, a microprocessor 22 and a location prompt module 23. The only difference between the device 20 of this embodiment and the device 10 of the first embodiment is that the location prompt module 23 includes a LED indicator 231 and a LED driving circuit 232 for driving the LED indicator 231, the LED driving circuit 232 being connected with the microprocessor 22. When the location prompt module 23 is working under the control of the microprocessor 22, the LED indicator 231 will be lighted or make flashing light so as to provide guidance to user for finding a parked vehicle.

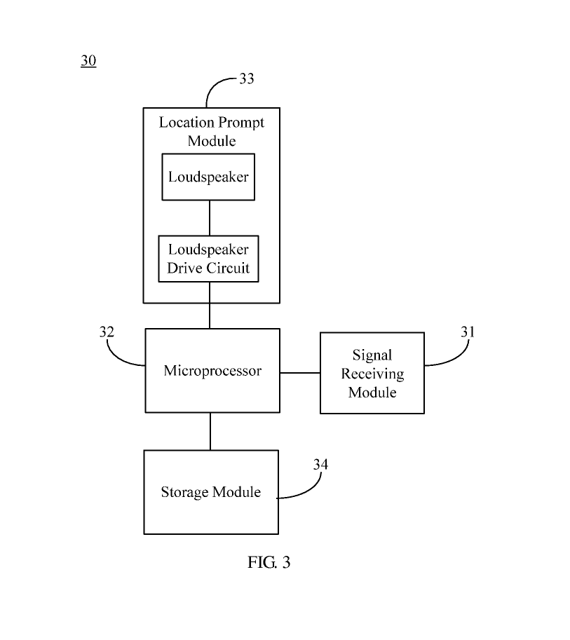

FIG. 3 illustrates a device for finding a parked vehicle according to the third embodiment of the present invention. Referring to FIG. 3, the device 30 according to this embodiment still include a signal receiving module 31, a microprocessor 32 and a location prompt module 33, and further includes a storage module 34 for storing preset user information. The storage module 34 is connected with the microprocessor 32 so that the microprocessor 32 can obtain the preset user information stored in the storage module. In some embodiment, for example in this embodiment, the preset user information includes identification code of the mobile communication terminal cooperated with the device 30, such as phone number (one or more than one mobile communication terminals can be bound with the device according to the requirements of users, that is, one or more than one phone numbers can be restored in the storage module), or other identification code which can represent the identity of user. The request signal sent to the device 30 from the mobile communication terminal includes request information and further includes real-time user information, such as identification code of this mobile communication terminal (such as phone number). The microprocessor 32 of the device 30 will compare the real-time user information obtained with the preset user information stored in the storage module 34 so as to determine whether the user is legitimate. If the real-time user information can match with the preset user information, the microprocessor 33 will send a control signal to the location prompt module 33 so that the location module 33 will send out a prompt signal to prompt the user where the parked vehicle is. And if the real-time user information cannot match with the preset user information, the microprocessor 33 will not respond to the request signal sent by the mobile communication terminal and the location module 33 will not be triggered. In this case the device 30 will wait for a new request signal.

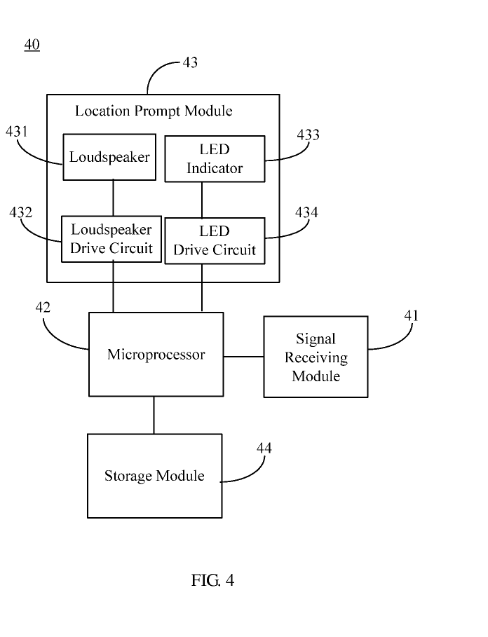

FIG. 4 illustrates a device for finding a parked vehicle according to the fourth embodiment of the present invention. Referring to FIG. 4, most of the structure of the device 40 according to this embodiment is the same as the device 30 of the third embodiment, it also includes a signal receiving module 41, a microprocessor 42 and a location prompt module 43, and the main difference is that the location prompt module 43 of this embodiment includes a voice prompt unit and a light prompt unit. The voice prompt unit includes a loudspeaker 431 and a loudspeaker drive circuit 432 provided for driving the loudspeaker 431, the loudspeaker drive circuit 432 being connected with and controlled by the microprocessor 42; and the light prompt unit includes a LED indicator 433 and a LED driving circuit 434 for driving the LED indicator 432, the LED driving circuit 434 is connected with and controlled by the microprocessor 42. Under the control of microprocessor 42, the loudspeaker 431 and LED indicator 432 can work at the same time so as to play beep sound and be lighted or make flashing light, respectively, thereby providing more efficient guidance to user for finding a parked vehicle.

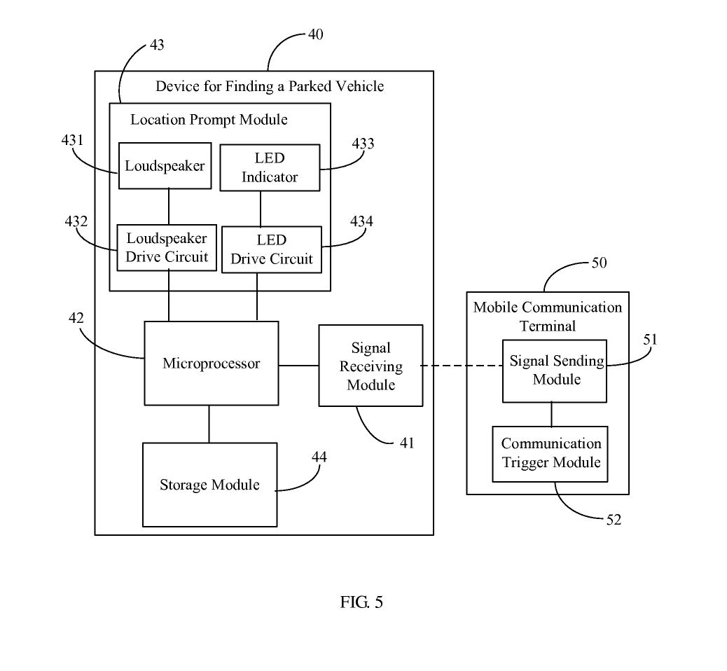

There is further provided a system for finding a parked vehicle and FIG. 5 illustrates the system for finding a parked vehicle according to an embodiment of the present invention. In this embodiment, the system for finding a parked vehicle includes a device for finding a parked vehicle which is installed in the vehicle (the device is one of the above-mentioned devices 10, 20, 30 and 40, and the device 40 is taken as an example to illustrate as follows) and a mobile communication terminal 50 of user. The mobile communication terminal 50 can be a mobile phone or a tablet device with a function of telecommunication or other terminals with such a function. The mobile communication terminal 50 includes a signal sending module 51, which is a remote wireless communication module and provided for sending request signal to the device 40 in a way of sending text message or dialing. Particularly, the signal receiving module 41 (remote wireless communication module) of device 40 and the signal sending module 51(remote wireless communication module) of mobile communication terminal 50 can be a GSM module, CDMA module, CDMA2000 module, WCDMA module, TD-SCDMA module, TD-LTE module or FDD-LTE module, all of which must be based on a SIM card for communication. When the user want to use the function of finding a parked vehicle of the device 40, the device 40 can be enabled by means of writing a text message and sending it to the device 40 or dialing to the device 40.

In a preferred embodiment, there is provided a communication trigger module 52 in the mobile communication terminal 50 for triggering the mobile communication terminal 50 to send text message or dial to the device 40 automatically. The communication trigger module 52 can be achieved by application program (APP), by means of which the telecommunication number of the device 40 and the contents about the request information can be preset. When the user wants to send a request signal to the device 40 for finding a parked vehicle, just need to start the above-mentioned APP and operate it, such as press a start key, which is easy to use.

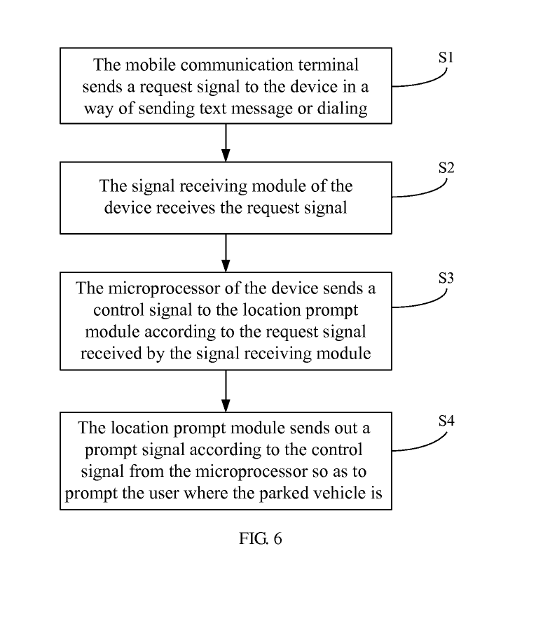

Additionally, there is further provided a method for finding a parked vehicle based on the above-mentioned system. FIG. 6 illustrates a flow chart of the method for finding a parked vehicle according to an embodiment of the present invention. The method of the present invention includes following steps:

Step S1: the mobile communication terminal sends a request signal to the device in a way of sending text message or dialing. In this step, the users can writing a text message and sending it to the device 40 or dialing to the device 40 directly by themselves, or do it by means of the above-mention APP.

Step S2: the signal receiving module of the device receives the request signal. Preferably, the request signal received by the signal receiving module not only includes request information but also includes real-time user information such as identification code of the mobile communication terminal (such as phone number).

Step S3: the microprocessor of the device sends a control signal to the location prompt module according to the request signal received by the signal receiving module. Preferably, in this step, there further carry out a step of user identification. The microprocessor compares the real-time user information from the signal receiving module with the preset user information so as to determine whether the user is legitimate. If the real-time user information can match with the preset user information, the microprocessor of the device will send a control signal to the location prompt module so that the step S4 will be executed; and if the real-time user information cannot match with the preset user information, the microprocessor will not respond to the request signal sent by the mobile communication terminal and the location module will not be triggered. In this case the device will wait for a new request signal.

Step S4: the location prompt module sends out a prompt signal according to the control signal from the microprocessor so as to prompt the user where the parked vehicle is. For example, under the control of microprocessor, the loudspeaker and LED indicator can work at the same time so as to play beep sound and be lighted or make flashing light, respectively, thereby providing more efficient guidance to user for finding a parked vehicle.

In conclusion, the device of the present invention is mainly composed of signal receiving module, microprocessor and location prompt module. By receiving external signal, the location prompt module can be started up so as to prompt the user where the parked vehicle is. Such a simple structure can achieve a function of finding a parked vehicle, which can significantly reduce costs. In addition, due to the signal receiving module being achieved by remote wireless communication module, the device of the present invention can be cooperated with a widely used mobile communication terminal such as mobile phone or tablet device with a function of telecommunication, thus no additional remote control device is needed in order to control the device for finding a parked vehicle. Thus, it is easy to use, has lower costs and it is not restricted by space and distance, all of which can meet the demand of consumers and then can bring good economic benefits. Similarly, the system and method of the present invention also have the above-mentioned advantages.

It should be noted that the device of the present invention further includes other fundamental circuit modules, such as a power supply module for supplying power for other modules, all of which are well known to a person skill in the art and need not be repeated here.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A device for finding a parked vehicle, provided for being installed in a vehicle and cooperated with a mobile communication terminal of user, comprising a signal receiving module, a microprocessor and a location prompt module, wherein the signal receiving module is a remote wireless communication module, which is used for making wireless communication with the mobile communication terminal thereby receiving a request signal sent by the mobile communication terminal in a way of sending text message or dialing; the microprocessor is connected with the signal receiving module and the location prompt module for sending a control signal to the location prompt module according to the request signal received by the signal receiving module; and the location prompt module is provided for sending out a prompt signal according to the control signal from the microprocessor so as to prompt the user where the parked vehicle is.

2. The device for finding a parked vehicle according to claim 1, wherein the remote wireless communication module is GSM module, CDMA module, CDMA2000 module, WCDMA module, TD-SCDMA module, TD-LTE module or FDD-LTE module.

3. The device for finding a parked vehicle according to claim 1, wherein the device further comprises a storage module, which is provided for storing preset user information; the request signal comprises request information and real-time user information; and the microprocessor is connected with the storage module so as to obtain the preset user information stored in the storage module and then compare the preset user information with the real-time user information from the signal receiving module so as to determine whether the user is legitimate.

4. The device for finding a parked vehicle according to claim 1, wherein the location prompt module comprises a voice prompt unit and/or a light prompt unit; the voice prompt unit comprises a loudspeaker and a loudspeaker drive circuit provided for driving the loudspeaker, the loudspeaker drive circuit being connected with and controlled by the microprocessor; and the light prompt unit comprises a LED indicator and a LED driving circuit for driving the LED indicator, the LED driving circuit being connected with and controlled by the microprocessor.

5. The device for finding a parked vehicle according to claim 2, wherein the location prompt module comprises a voice prompt unit and/or a light prompt unit; the voice prompt unit comprises a loudspeaker and a loudspeaker drive circuit provided for driving the loudspeaker, the loudspeaker drive circuit being connected with and controlled by the microprocessor; and the light prompt unit comprises a LED indicator and a LED driving circuit for driving the LED indicator, the LED driving circuit being connected with and controlled by the microprocessor.

6. The device for finding a parked vehicle according to claim 3, wherein the location prompt module comprises a voice prompt unit and/or a light prompt unit; the voice prompt unit comprises a loudspeaker and a loudspeaker drive circuit provided for driving the loudspeaker, the loudspeaker drive circuit being connected with and controlled by the microprocessor; and the light prompt unit comprises a LED indicator and a LED driving circuit for driving the LED indicator, the LED driving circuit being connected with and controlled by the microprocessor.

7. A system for finding a parked vehicle, comprising a device for finding a parked vehicle which is installed in the vehicle and a mobile communication terminal of user, wherein the mobile communication terminal comprises a signal sending module, which is a remote wireless communication module, provided for sending request signal to the device in a way of sending text message or dialing; the device for finding a parked vehicle comprises a signal receiving module, a microprocessor and a location prompt module; the signal receiving module is a remote wireless communication module, which is used for making wireless communication with the mobile communication terminal thereby receiving a request signal from the signal sending module; the microprocessor is connected with the signal receiving module and the location prompt module for sending a control signal to the location prompt module according to the request signal received by the signal receiving module; and the location prompt module is provided for sending out a prompt signal according to the control signal from the microprocessor so as to prompt the user where the parked vehicle is.

8. The system for finding a parked vehicle according to claim 7, wherein a communication trigger module is provided in the mobile communication terminal for triggering the mobile communication terminal to send text message or dial to the device automatically.

9. The system for finding a parked vehicle according to claim 7, wherein the device further comprises a storage module, which is provided for storing preset user information; the request signal comprises request information and real-time user information; and the microprocessor is connected with the storage module so as to obtain the preset user information stored in the storage module and then compare the preset user information with the real-time user information from the signal receiving module so as to determine whether the user is legitimate.

10. The system for finding a parked vehicle according to claim 7, wherein the location prompt module comprises a voice prompt unit and/or a light prompt unit; the voice prompt unit comprises a loudspeaker and a loudspeaker drive circuit provided for driving the loudspeaker, the loudspeaker drive circuit being connected with and controlled by the microprocessor; and the light prompt unit comprises a LED indicator and a LED driving circuit for driving the LED indicator, the LED driving circuit is connected with and controlled by the microprocessor.

11. The system for finding a parked vehicle according to claim 8, wherein the location prompt module comprises a voice prompt unit and/or a light prompt unit; the voice prompt unit comprises a loudspeaker and a loudspeaker drive circuit provided for driving the loudspeaker, the loudspeaker drive circuit being connected with and controlled by the microprocessor; and the light prompt unit comprises a LED indicator and a LED driving circuit for driving the LED indicator, the LED driving circuit is connected with and controlled by the microprocessor.

12. The system for finding a parked vehicle according to claim 9, wherein the location prompt module comprises a voice prompt unit and/or a light prompt unit; the voice prompt unit comprises a loudspeaker and a loudspeaker drive circuit provided for driving the loudspeaker, the loudspeaker drive circuit being connected with and controlled by the microprocessor; and the light prompt unit comprises a LED indicator and a LED driving circuit for driving the LED indicator, the LED driving circuit is connected with and controlled by the microprocessor.

13. A method for finding a parked vehicle based on the system claimed in claim 7, comprising following steps:
(a) the mobile communication terminal sends a request signal to the device in a way of sending text message or dialing;
(b) the signal receiving module of the device receives the request signal;
(c) the microprocessor of the device sends a control signal to the location prompt module according to the request signal received by the signal receiving module; and
(d) the location prompt module sends out a prompt signal according to the control signal from the microprocessor so as to prompt the user where the parked vehicle is.

14. The method for finding a parked vehicle according to claim 13, wherein the device further comprises a storage module, which is provided for storing preset user information; the request signal comprises request information and real-time user information; the microprocessor is connected with the storage module so as to obtain the preset user information stored in the storage module; and the step (c) comprises following steps:
the microprocessor compares the real-time user information from the signal receiving module with the preset user information so as to determine whether the user is legitimate; if the real-time user information can match with the preset user information, the step (d) will be executed; and if the real-time user information cannot match with the preset user information, the device will not respond to the request signal sent by the mobile communication terminal and wait for a new request signal.
